(19) United States
(12) Patent Application Publication
(10) Pub. No.: US 2026/0359153 A1
(43) Pub. Date: Nov. 12, 2026

(54) METHOD FOR MONITORING UNCERTAINTY REGARDING THE RELIABILITY AND TECHNOLOGICAL RISK ASSOCIATED WITH THE DEVELOPMENT OF NEW EQUIPMENT

(71) Applicants: PETRÓLEO BRASILEIRO S.A. - PETROBRAS, Rio de Janeiro (BR); UNIVERSIDADE FEDERAL DE PERNAMBUCO - UFPE, Recife (BR)

(72) Inventors: MANOEL FELICIANO DA SILVA JUNIOR, Rio de Janeiro (BR); EDUARDO JOSÉ NOVAES MENEZES, Recife (BR); RAFAEL VALENÇA AZEVEDO, Recife (BR); MÁRCIO JOSÉ DAS CHAGAS MOURA, Recife (BR); MARCOS VINICIUS DA SILVA NOBREGA, Rio de Janeiro (BR); ISIS DIDIER LINS, Recife (BR); CAIO BEZERRA SOUTO MAIOR, Recife (BR)

(21) Appl. No.: 19/665,184

(22) Filed: May 1, 2026

(30) Foreign Application Priority Data
May 8, 2025 (BR) 1020250092212

(51) Int. Cl. G06F 11/00

(52) U.S. Cl. CPC G06F 11/008; G06F 2201/805

(57) ABSTRACT

The present invention discloses a systematic approach for monitoring the reliability, uncertainty, and technological risk of new equipment under development, in TRL 2 in the process of obtaining TRL 3. The risk is composed of the criteria of cost, duration, integration, and reliability. The method disclosed herein supports the determination of the target reliability and the target uncertainty associated thereto at each Gate or TRL of the equipment development. At each Gate or TRL, the equipment must reach the uncertainty target regarding the reliability for the development to proceed to the next Gate or TRL. This information supports the assessment of technological risk by using a multi-criteria method. If the target is not reached, a change in the direction of equipment development is suggested. The assessment of the equipment's reliability and uncertainty is based on expert opinions, Bayesian methodology, FMECA, FTA, and PPoF, in which FMECA comprises including a new component called a stressor, which modifies the PPoF models depending on whether the stressor acts instantaneously on certain demands or continuously throughout the production, causing a cumulative degradation process, in order to adapt the invention's method to very long mission times, on the order of decades.

### CROSS REFERENCE TO RELATED APPLICATIONS

The present application claims priority to BR Patent Application No. 1020250092212 filed on May 8, 2025, which is hereby incorporated by reference in its entirety.

### FIELD OF THE INVENTION

The present invention falls within the field of oil engineering. More specifically, the present invention relates to well engineering, particularly to the development of completion equipment.

### BACKGROUNDS OF THE INVENTION

The development of new technologies is a complex process, often carried out in non-sequential steps, with many iterations, returns to previous tests or ideas, rework, and possibilities of failure. In short, the creation of a new technology is an activity characterized by and based on risk. However, although aware of and dealing with this fact daily, the decision-makers and all stakeholders involved in the development of new technologies do not have a tool capable of assessing the risk involved in innovation in quantitative terms. This risk involves considering several dimensions or criteria such as cost, time, integration, and the reliability of the new technology. With regard to the reliability dimension, in the development of new technologies, there is a reliability target and a target uncertainty to be met. Often, the reliability of the equipment under development is assessed by suppliers based on data that may be little representative, such as generic data and data from equipment developed for other applications. Then, to ensure that the technology under development actually meets the reliability requirements, it is necessary to monitor the uncertainty related to the same, by using its quantification and updating from scarce data and from different sources, taking into account the cost, time, and laboratory infrastructure constraints for conducting reliability tests.

Currently, the standard method for verifying whether the technology is being satisfactorily developed is to carry out functional tests required by standards at each step of development. Essentially, this procedure boils down to a single verification of the operation of the new technology or its subsystems and components. Characterizing reliability quantitatively by using only functional tests is quite limited, compromising the risk assessment at each step of development. At the end of the innovation process, some manufacturers, seeking a quantitative measure of reliability, apply Reliability Demonstration Tests (RDTs) to verify whether the equipment meets a specific reliability requirement and/or reliability growth tests for components or subsystems associated with a specific failure mechanism before the final phases of equipment development itself. The RDTs do not allow for the estimation of reliability and confidence level, they only allow determining whether a minimum reliability limit is exceeded or not for a given confidence level. Like the reliability growth tests, they can be specific to components and subsystems and, per se, lack the systemic view necessary for estimating the reliability of the equipment as a whole. In addition, data from previous versions of similar equipment are often used as if they were entirely relevant to analyze the reliability of the equipment under development, even when the operating contexts and/or operating modes of both are quite distinct, which constitutes a conceptual error. Finally, the approaches currently used to obtain reliability, even in a simplified way, are not integrated with the other dimensions of risk in the same methodological framework, impacting its assessment throughout the development process as a subsidy for decision-making.

### STATE OF THE ART

The document “Bayesian prior distribution based on generic data and experts' opinion—A case study in the O&G industry” (Maior et al, Journal of Petroleum Science and Engineering, Volume 210, 2022, 109891, ISSN 0920-4105, https://doi.org/10.1016/j.petrol.2021.109891) discloses an approach to estimating reliability that does not require direct elicitation of parameters to define informative prior distributions for the reliability function using fault tree analysis, expert opinions, and/or generic data at the system level of the equipment under development. Specifically, the method of moments (MM) and maximum entropy (ME) are adopted to propagate down the uncertainty from the system level through the failure modes to the basic events of the fault tree, weighted by expert knowledge of the failure behavior. Then, having all the previous distributions of the basic events, the information can be propagated upwards based on Monte Carlo simulation to update the reliability distribution of the system.

The document “Using experts' opinion for Bayesian prior reliability distribution of on-demand equipment: A case study of a novel sliding sleeve valve for open-hole wells” (Macedo et al, Reliability Engineering & System Safety, Volume 238, 2023, 109430, ISSN 0951-8320, https://doi.org/10.1016/j.ress.2023.109430) discloses a methodology for constructing an informative previous distribution for different failure mechanisms of new equipment operating on demand. The methodology is flexible enough to consider failure events caused by degradation over time and/or past demands. In addition, it involves an elicitation process to extract expert opinions on the probability of failure at the system level. Uncertainty regarding differing expert opinions is considered by modeling the opinion of each expert with a probability distribution and then aggregating the same through multiplicative error and Population Variability Analysis. Thus, the proposed methodology considers how the probability estimates vary among experts and defines a Bayesian informative previous distribution using only expert knowledge.

The document CN111008438A, titled “Umbilical cable multi-stage system reliability analysis method and device”, discloses a method and device for umbilical cable multi-stage system reliability analysis. The method comprises the steps S1—constructing a multi-stage umbilical cable fault tree model: performing the statistical analysis of the failure causes of an umbilical cable and constructing the umbilical cable fault tree model at different stages; S2—converting the multi-stage umbilical cable fault tree model to a multi-stage Bayesian network model; S3—solve the multi-stage Bayesian network model to obtain a time variation curve of the multi-stage reliability of the target umbilical cable; and S4—determine the reliability of each stage of the umbilical cable according to the time variation curve of reliability. According to the method, the complete life cycle reliability analysis is performed on the target umbilical cable, so that the safety assessment at the on-site operation stage can be carried out and suggestions for improvement can be provided for weak links.

The document “Technology readiness and risk assessments: A new approach” (John C. Mankins, Acta Astronautica, Volume 65, Issues 9-10, 2009, Pages 1208-1215, ISSN 0094-5765, https://doi.org/10.1016/j.actaastro.2009.03.059) discloses that systems that rely on the application of new technologies inevitably face three major challenges during the development: performance, schedule, and budget. Technology research and development (R&D) programs are typically advocated on the grounds that these investments will substantially reduce the uncertainty in all three dimensions of project management. However, if the initial R&D is poorly implemented, the subsequent system developments that plan to employ the resulting advanced technologies will suffer from cost overruns, schedule delays, and constant erosion of the initial performance objectives. Often, it is essential for senior management to be able to determine which of these two paths is more likely and respond appropriately. The challenge for systems and technology managers is to make clear and well-documented assessments of technology readiness and risks, and to do so at key points in the program lifecycle. Several approaches have been used to assess technology maturity and risk in order to better anticipate later system development risks. Technology Readiness Levels (TRLs), developed by NASA, are a discipline-independent programmatic figure of merit (FOM) that allows for more effective assessment and communication of the maturity of new technologies. Another widely used management tool is the “risk matrix,” which relies on a graphical representation of uncertainty and consequences. However, for the most part, these various methodologies have not had any explicit interrelation. This document examines the past uses of current methods to improve the R&D outcomes and will highlight some of the limitations that may arise. In this context, a new concept for integrating the TRL methodology and the “risk matrix” concept will be described. The document concludes with observations on prospective future directions for the important new concept of integrated “technology readiness and risk assessments.”

### SUMMARY OF THE INVENTION

The present invention discloses a method for monitoring uncertainty about reliability and technological risk based on the DRUM+RM approach developed by the inventors, comprising: a) supporting the allocation process for defining the minimum required reliability level and the maximum tolerated uncertainty; b) performing selection of concepts, comprising choosing one or more concepts based on a multi-criteria methodology; c) modeling the reliability of the equipment, comprising: c1) determining the failure mechanisms and their logical relations; c2) creating models that describe the reliability of the failure mechanisms; and c3) developing MRM; d) estimating a prior distribution of reliability, including: d1) eliciting expert opinions; d2) collecting and processing partially relevant data; d3) obtaining a distribution over the MRM parameters; and d4) obtaining the reliability distribution over mission time; e) planning reliability tests; f) Bayesian reliability update, comprising: f1) collecting data from tests performed at the current Gate; f2) updating the distribution of the MRM parameters for the current Gate; and f3) updating the mission time reliability distribution for the current Gate; g) assessing the technological risk at the current Gate, comprising: g1) verifying the residual uncertainty about the reliability target; g2) verifying the updated cost and duration estimates of the project; g3) defining if the technological risk is tolerable for the current Gate; g3.1) if not, deciding on the type of action to be taken: g3.1.1) if design alteration, suggesting and implementing the design change and returning to step (c); g3.1.2) if new tests are to be performed, returning to step (e); g3.1.3) if abandoning the project, determining that the technology is inadequate and terminating the project; g3.2) if yes, verifying if the current Gate is the final Gate; g3.2.1) if yes, determining that the equipment is adequate; g3.2.2) if no, proceeding to the next Gate and returning to step (f).

The assessment of the reliability and uncertainty of the equipment is based on expert opinions, Bayesian methodology, FMECA, FTA and PPoF, where FMECA comprises a new component called stressor, which represents the physical variable responsible for the failure mechanism identified in the FMECA, being determinant in the definition of the PPoF model, depending on the nature of the stressor and the frequency with which it acts on the component, whether instantaneously in certain demands of the operation or continuously throughout production, causing a cumulative degradation process, thus adapting the invention method to very long mission times, on the order of decades. In this way, in the context of the invention, the innovative activity involves defining the stressor component associated with the failure mechanism component, which will be used to choose the best PPoF law that models that determined equipment failure scenario under analysis.

### BRIEF DESCRIPTION OF THE DRAWINGS

The present invention will now be described below with reference to typical embodiments thereof and also with reference to the accompanying drawings, in which:

FIG. 1 illustrates a compact configuration of the DRUM+RM approach with its steps according to the present invention;

FIG. 2 illustrates the adapted FMECA approach used in the DRUM+RM Methodology according to the present invention;

FIG. 3 illustrates an example of a fault tree according to the present invention;

FIG. 4 is a detailed exemplary flowchart of the steps of the method according to the present invention;

FIG. 5A illustrates the first part of an exemplary elicitation form according to the present invention;

FIG. 5B illustrates the second part of the exemplary elicitation form according to the present invention;

FIG. 5C illustrates the third part of the exemplary elicitation form according to the present invention.

### DETAILED DESCRIPTION OF THE INVENTION

Specific embodiments of the present disclosure are described below. In an effort to provide a concise description of these embodiments, all features of an actual implementation may not be described in the specification. It should be appreciated that in the development of any actual implementation, as in any engineering or design project, numerous specific implementation decisions must be made to achieve the specific objectives of the developers, such as compliance with system and business related constraints, which may vary from one implementation to another. In addition, it should be appreciated that such a development effort may be complex and time-consuming, but would nevertheless be a routine design and manufacturing undertaking for those of ordinary skill having the benefit of this disclosure.

The present invention proposes a new methodology for monitoring the uncertainty about reliability and the inherent technological risk associated with the development of new equipment, which is at TRL 2 and in the process of reaching TRL 3. The developed methodology is called DRUM+RM, and is divided into two parts: (i) DRUM (Development Supported by Reliability Uncertainty Monitoring) and its steps (data collection, reliability modeling and reliability prediction) and (ii) RM (risk monitoring) and its step (selection of concepts).

In DRUM, the data collection step includes support for reliability testing, expert elicitation, and the processing of partially relevant data. The reliability prediction step uses Bayesian methodology to predict the equipment reliability, and the reliability modeling step is dedicated to creating models that describe the equipment reliability. In turn, in RM, the step of selection of concepts incorporates a multi-criteria method to select different concepts (i.e., designs) from a set of available concepts, which should proceed in the development process. The criteria used are duration, cost, integration, and reliability, and they are assessed for each of the concepts. The step of selection of concept is applied at least twice during the development of the new technology: Before Gate 0 and between Gates 1 and 2.

Based on the initial allocation of system reliability, requirements are established for the reliability of the equipment under development during the specified mission time and for the uncertainty associated therewith. These requirements are understood as targets to be achieved by the new technology at the end of the development process and, therefore, are used as input for DRUM. Initially, the multilevel reliability model (MRM) that describes the equipment's reliability is developed in the reliability modeling step. Then, in the reliability prediction step, the MRM parameters are determined; at the beginning of the development, a prior probability distribution of the equipment's reliability during the mission time is obtained based on information provided by the data collection step (expert opinion and/or partially relevant data), from which the initial uncertainty associated therewith is obtained. As new evidences from tests are acquired and consolidated in the data collection step, the reliability prediction step uses the Bayesian methodology and generates a new estimate of the equipment's reliability distribution during the mission time, allowing the uncertainty to be monitored over time. The uncertainty acts as a control variable for the system to achieve the established goal. Specifically, by applying the step of selection of concepts of the RM at the beginning of the development process (before Gate 0), the initial target uncertainty on the reliability during the mission time is obtained by aggregating the uncertainties of the multiple concepts (e.g., 4 or 5) selected via a multi-criteria method to move forward. Furthermore, DRUM provides the distribution of mission-time reliability that is used in quantifying the reliability criterion necessary for monitoring technological risk by the RM part. The desired output is a system that meets the predefined uncertainty and risk targets. If the new technology meets the reliability requirements, as well as the other criteria that make up the technological risk (duration, cost, integration), the development process will proceed. Technological risk is understood as the uncertainty associated with the development of a specific technology. DRUM and RM play a crucial role in delivering the new technology, ensuring that it meets the determined reliability, uncertainty, and risk requirements, resulting in a reliable and safe system for its intended use.

For simplicity, the method of the present invention will be described below based on an exemplary application in which the new equipment under development is a downhole piece of equipment. However, it will be evident to those skilled in the art that the present invention is not limited to this type of equipment. Adaptations and adjustments to specific applications are possible without departing from the scope of the present invention.

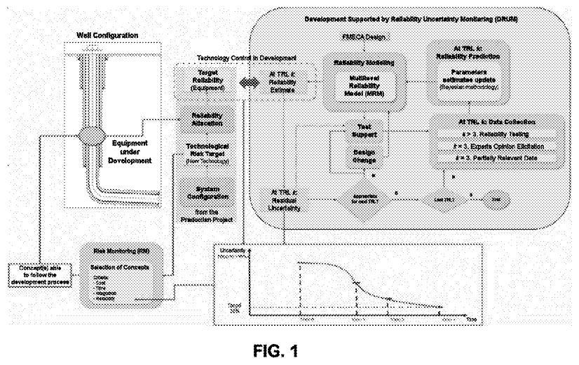

The DRUM+RM methodology is structured in steps: data collection, reliability modeling, and reliability prediction in DRUM, and selection of concepts in RM. As briefly illustrated in FIG. 1 (and in detail in FIG. 4), the methodology provides for the sequential steps described below.

### a)—Step 1: Definition of Reliability Requirements

The reliability target for the pre-specified mission time and the uncertainty target associated therewith for the equipment under development must be derived from a reliability allocation procedure that takes the well system into account. For equipment already developed within the well system, the reliability functions are well defined. However, it should be considered that these reliability functions were obtained from historical data in different applications, which can be characterized as data that are only partially relevant to the well system in question. In this way, the method of processing partially relevant data should be adopted to weigh such reliability values before the allocation process is carried out. Thus, the reliability and uncertainty targets for the technologies to be developed can then be adequately determined by the allocation process, in order to meet an overall target for the well system.

The uncertainty target must be met at the end of the development process and the uncertainties observed throughout this process can be compared to the same, characterizing the process of monitoring the uncertainty about the reliability incorporated by DRUM. This uncertainty about the reliability is then combined with the other criteria that make up the risk during the development, allowing for more strategic risk-based decision-making, which is the objective of RM.

### b)—Step 2: Selection of Concepts

The methodology developed for selection of concepts quantitatively integrates the reliability by using the Additive Ratio Assessment (ARAS) method. The approach incorporates the estimation of reliability through prior distributions obtained by means of the expert elicitation. The reliability criterion is then translated into a relative scoring scale (1=much worse, 2=worse, 3=reference, 4=better, 5=much better), in which the simple average of the expected reliabilities of the alternatives serves as a reference. In this way, concepts with reliability higher than the average value receive higher scores, while those with lower reliabilities are proportionally penalized. This approach ensures that the reliability is considered quantitatively and objectively in the decision-making process, reducing subjectivity and allowing the integration of this criterion with other essential factors.

The assessment criteria-cost, duration, integration, and reliability-have weights defined by experts according to their relevance to the project, using an importance scale of 1 to 5. In this way, more critical criteria exert greater influence on the final decision. After assigning scores and weights, the weighted values are combined in the ARAS structure, resulting in a weighted sum that determines the final ranking of the alternatives. This strategy allows for a structured assessment, ensuring greater transparency, traceability, and alignment with the project objectives.

### c)—Step 3: Reliability Modeling of the Technology Under Development

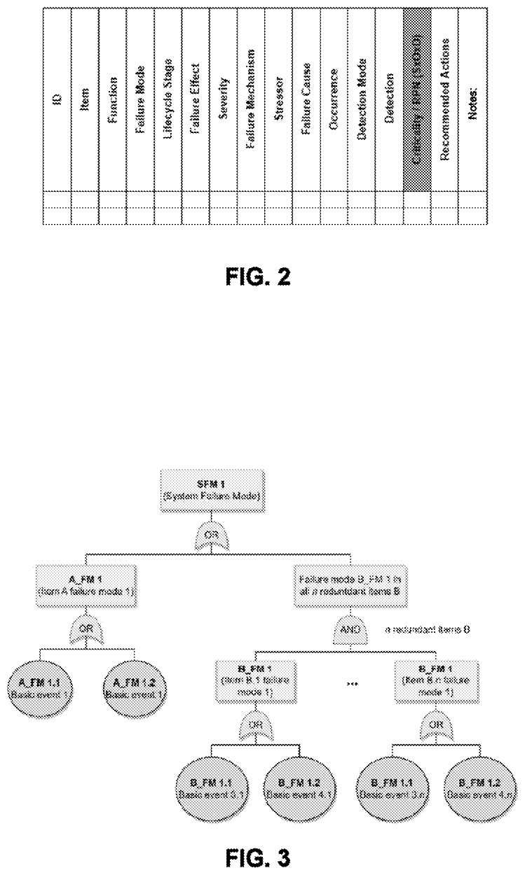

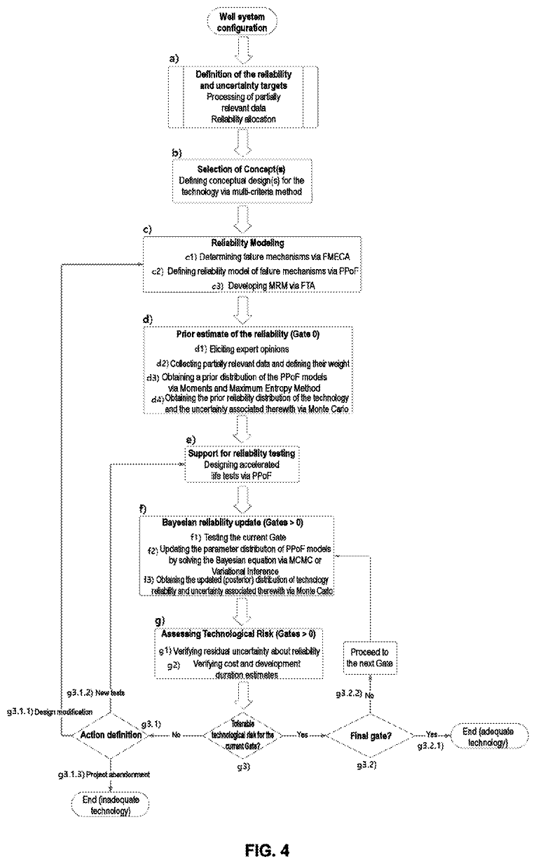

The first step necessary to obtain a reliability estimate for a technology under development consists of its modeling and analysis, from a topological and causal point of view. It is necessary to define a model capable of representing the features of complex systems, in order to subsequently aggregate the data that will be collected. For this, the DRUM +RM methodology establishes a Multilevel Reliability Model (MRM). The MRM begins with substep c1): determining the failure mechanisms and their logical relations, in which a Failure Mode, Effects and Criticality Analysis (FMECA) is performed. Although FMECA is an already developed tool, DRUM+RM proposes its own FMECA specifically developed to facilitate the application of MRM. A model of this FMECA is presented in FIG. 2. The main difference is the inclusion of the column corresponding to the stressor, which allows specialists to assess which physical variable is responsible for the failure. This information is useful for planning the tests to be performed. Another fundamental point is the establishment of the Risk Priority Number (RPN), which consists of multiplying the occurrence, detection, and severity scores. The RPN is the main filter for analyzing which failure modes will be included in the analysis and which will be considered irrelevant. Next, the FMECA information is transformed into a Fault Tree Analysis (FTA). This means that the data entered in the FMECA spreadsheet will be processed and their logical relations will be obtained, indicating, for each component, a logical failure path. In this way, the top event failure is decomposed into several basic failure events. The system is divided topologically (system, subsystem, component) and in its failure paths (basic events, intermediate events, top event). A typical example of FTA is shown in FIG. 3.

After defining the FTAs, the DRUM+RM methodology moves on to step c2): creating models that describe the reliability of the failure mechanisms, which establishes how the reliability estimate of each failure mode will be processed. For this, an approach called Probabilistic Physics of Failure (PPoF) is used to determine the reliability models of each basic event. The novelty of the PPoF approach, in this case, is its coupling with a failure analysis approach for the top event, by means of the propagation through the logic gates. The first point to define the models of the basic events consists of considering the type of system operation: on demand or in continuous operation. Stressors that act on demand are applied instantaneously to a component, only during a procedure, such as installation, actuations (e.g., opening or closing valves), interventions, etc. These types of failure mechanisms are associated with a probability of failure on demand (PFD), ρ, which means that when the demand occurs, the failure mode will occur with a probability ρ. For example, during the installation of an expandable packer, a pressurization procedure is performed by applying pressure to the metal expandable jacket. The expandable jacket may burst during this procedure with probability ρ. For failure mechanisms whose stressors continuously affect the item, or at high frequency, a time-to-failure distribution is used. This includes environmental variables that act continuously on the item (e.g., temperature, axial loads, pressure differential, vibration, humidity, electrical potential, etc.) causing its failure due to mechanisms such as fatigue, corrosion, erosion, and so on. The appropriate choice for the time-to-failure distribution depends on the form of the PPoF model that best represents the failure mechanism. The PPoF modeling structure is subject to the nature of the underlying failure and degradation mechanism, which may be stress-life, damage-endurance, or performance degradation.

The final substep, c3, consists of developing the MRM based on the modeling obtained in substep c1 and the failure mechanisms obtained in substep c2.

### d)—Step 4: Prior Estimation of the Reliability (Gate 0)

Once the basic event models have been defined and the tests that will provide experimental data have been designed, it is necessary to define the prior distribution, which will provide the first reliability estimate. The prior distribution allows obtaining reliability and associated uncertainty even at TRL 3 (Technology Readiness Level), at the time of proof of concept. Information sources from expert opinion elicitation and/or similar equipment are used. The prior distribution will be updated at each TRL as new information (e.g., test data) becomes available.

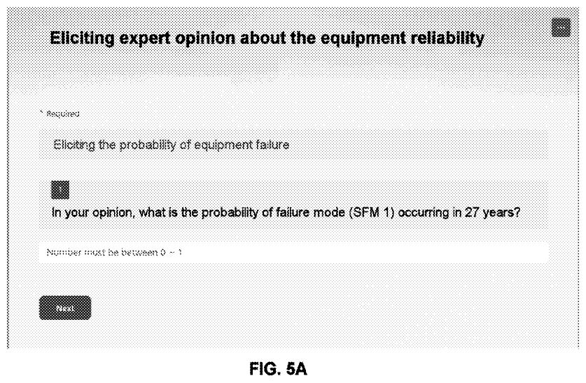

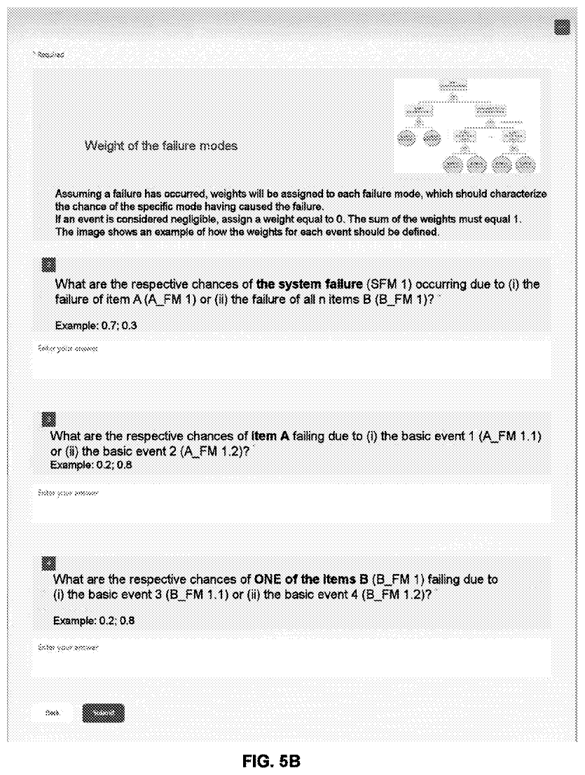

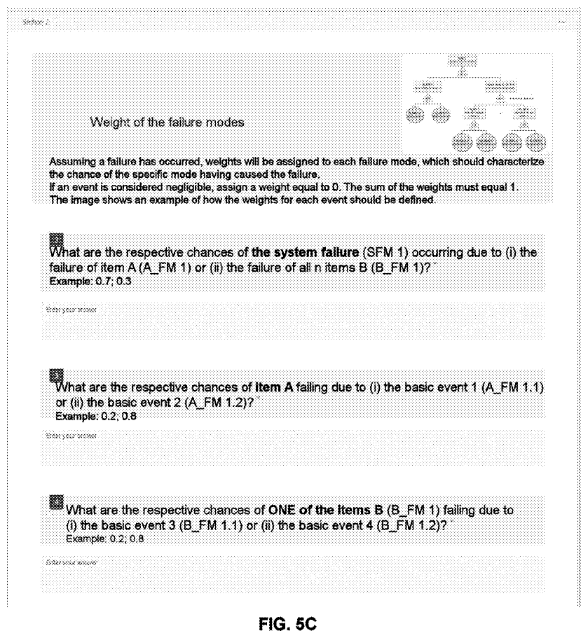

In substep d1, the expert opinions are elicited. To use expert opinion in determining prior reliability, it is necessary to develop a structured elicitation process. The elicitation aims to obtain estimates of the probability of occurrence of specific failure modes. For this, elicitation forms are generated based, for example, on the FTAs provided by the user. A non-limiting example of an elicitation form is found in FIGS. 5A to 5C. These forms are used to extract information about the probability of equipment failure in different failure modes. The elicitation can be performed remotely, but the participation of experts with different experiences and levels of knowledge regarding the equipment under analysis is essential. Then, a chief analyst must select the experts who will participate in the elicitation, taking into account the different levels of knowledge and experience. It is important to highlight that the experts will answer about the probability of failure of the top event (i.e., equipment failure), and next about the probabilities of the failure having been caused by the different failure modes, represented by the intermediate events immediately below the top event in the fault tree, and so on.

Substep d2 refers to the collection and processing of partially relevant data. For similar equipment, the DRUM+RM methodology provides for the use of relevance factors, which are calculated according to a systematic procedure that involves the main functional and operational features of the considered systems. Thus, criteria are defined (type of operation, geology, operational envelope, geometry, material), to which representative values are assigned, which are next compared by using distance measures. In the present description, distance is a measure of similarity between equipment, so that small distances mean a large similarity and large distances mean a small similarity. The greater the distance between the equipment, the less relevant the data from the similar equipment will be on the reliability of the equipment being developed.

With this information, the level of basic events is achieved and there can be used the method of moments or the maximum entropy method to perform substep d3): obtaining a distribution over the MRM parameters, which consists of estimating the prior distribution for the probability of occurrence of each of the same. With the prior distributions of the basic events defined, substep d4 is performed): obtaining the mission time reliability distribution, where the uncertainty is propagated in a bottom-up approach that uses Monte Carlo Simulation to find the prior probability distribution of the top event, associated with equipment failure and, complementarily, with the reliability of the equipment under analysis.

### e)—Step 5: Support for Reliability Tests

After identifying the basic events and their associated failure mechanisms, the next step provided by DRUM +RM is the project of specific tests for data collection. In general, two types of tests are possible: functional tests and long-term reliability tests. The functional tests are those normally performed in industry standard qualification programs. However, they are not able to provide reliability estimates, given that they are performed in a short time interval and with a very small number of samples. On the other hand, the traditional long-term reliability tests are not suitable for the oil and gas industry, as mission times are very long, on the order of decades. In this sense, the most widely used approach in the prior art is reliability demonstration tests (RDTs). These tests do not provide measures of reliability or uncertainty distribution throughout the process; they only guarantee, if there is no failure, that the reliability is above a determined level with the established uncertainty.

To be able to evolve the perspective of testing in the industry, using specific reliability tests, the accelerated testing methodology is suggested. In this way, it is possible to deal with long mission times in feasible times from a cost and duration point of view. The main way to do this is the physical modeling of the failure mechanism, via PPoF, described in Step 3 (S3), and the use of acceleration factors, performing accelerated tests. These two methods are intrinsically connected.

The accelerated testing methodology consists of using PPoF equations to predict which stressor levels should be applied to emulate field use in a shorter time, using more severe stresses than normally expected. The main equation relating PPoF and accelerated testing is expressed by the acceleration factor, and the relation between the stressor and life should be established based on a linear, exponential, power-law, or multi-stress relation. The specific relation should be defined based on the physical modeling of the failure mechanism, but general guidelines can be established. The thermal mechanisms are usually modeled by the exponential relation, while the mechanical fatigue mechanisms usually employ the power law. When coupled mechanisms are present, the multi-stress models are adopted.

Thus, it is possible to estimate which stressor level corresponds to the accelerated life of the component. This level can be used in the test, the result of which will represent the life distribution (or probability of failure) of the equipment under accelerated conditions. It can then be extrapolated to stresses under normal conditions through the likelihood function and the stressor-life relations presented.

### f)—Step 6: Bayesian Update of the Reliability (Gates>0)

As the development process evolves and a variety of data sources become available, the DRUM+RM methodology updates the reliability distribution parameters with the new test and field data that become available in subsequent TRLs through a Bayesian approach. Thus, for each TRL, starting from TRL 4, the present invention performs substep f1): collecting data from tests performed in the current Gate, where it determines what data should be obtained by means of tests of the equipment under development. Each type of equipment will require a particular test to extract certain information, so only the type of data and information required will be listed below. The person skilled in the art will be able to choose the appropriate test for particular applications without departing from the scope of the invention.

TRL 4:
Data type: Bench tests at the component level.

Information collected:
a. Test conditions and duration.
b. Number of tested specimens.
c. Complete, interval, and/or censored failure times.
d. Number of observed failures.

TRL 5:
Data type: Bench tests at the system level.

Information collected:
e. Test conditions and duration.
f. Number of tested specimens.
g. Complete, interval, and/or censored failure times.
h. Number of observed failures.

TRL 6:
Data type: Well laboratory tests at the system level.

Information collected:
i. Test conditions and duration.
j. Number of tested specimens.
k. Complete, interval and/or censored failure times.
l. Number of observed failures.

TRLs 7 and 8:
Data type:
m. TRL 7: Operation in one well for a predetermined time.
n. TRL 8: Operation in three wells for a predetermined time.

Collected information:
o. Complete, interval, and/or censored failure times.
p. Number of observed failures.

TRL 9:
Data type: Equipment operation in one or more wells.

Collected information:
q. Complete, interval, and/or censored failure times.

Number of observed failures.

Thus, the method moves to substep f2): updating the distribution of the MRM parameters to the current TRL. Each step of the development analysis (or TRL) consists of a Bayesian update, taking into account the particularities of each type of data or information available at that stage. Different posterior distributions for the MRM parameters are estimated at each decision epoch (Gate). The result of this estimation provides uncertainty distributions about the MRM parameters. From the FTAs or any other logical reliability diagram, the parameters are extrapolated to the global equipment failure event in substep f3): updating the mission-time reliability distribution for the current Gate, providing the associated reliability and uncertainty for the system under consideration at the established mission time.

As the prior distributions are defined, likelihood functions must be constructed from the data of tests performed in the following steps of the development process. Naturally, if the failure mechanism i is addressed by a specific test, then the likelihood of the data extracted from this test can be obtained as a function of θᵢ, based on the reliability model Rᵢ(t|θᵢ). In this way, let T_{i,k} be the set of tests performed at Gate k, which encompasses the event i, and E_{i,k} be the evidence collected from each test, wherein L(E_{i,k}|θᵢ) is the likelihood function of the obtained data. It can be said that the posterior distribution of the parameters θᵢ of MRM, obtained by means of a Bayesian updating, is given by equation 1:

πₖ(θᵢ|E_{i,k})∝πₖ₋₁(θᵢ|E_{i,k-1})×L(E_{i,k}|θᵢ) (1)
where:
πₖ is the posterior distribution at Gate k;
θᵢ is the failure mechanism of event i;
E_{i,k} is the evidence collected by testing event i at Gate k;
πₖ₋₁ is the prior distribution at Gate k;
L is the likelihood; and
E_{i,k-1} is the evidence collected by testing event i at Gate k−1.

At Gate k=0, the Bayesian inference θᵢ for comprises the step immediately prior to performing the first reliability test, when the prior distribution is obtained according to step (d). The methods used by the DRUM+RM methodology to perform the Bayesian update calculation include the analytical approach (when a conjugate prior distribution can be obtained for the likelihood functions), the Markov Chain Monte Carlo (MCMC) based approach, and Variational Inference.

### g)—Step 7: Assessing the Technological Risk (Gates>0)

As the reliability distributions are updated throughout the TRLs, it is possible to monitor and analyze the behavior of the uncertainty levels at each step of the development. The uncertainty curves, together with cost, duration, and integration criteria, can be used to analyze the risk associated with the new technology to be included in well configurations.

The uncertainty about the reliability target is expected to decrease across the Gates as new evidences about the reliability of the equipment become available, until it reaches the maximum permissible uncertainty target at one of the final Gates. The distance from the estimated uncertainty at a Gate to the uncertainty target is called Residual Uncertainty. In substep g1): verifying the residual uncertainty about the reliability target, the method calculates the residual uncertainty of the technology at the current Gate. Thus, throughout the Gates, the Residual Uncertainty must be verified to assess the risk that the target will not be reached at the end of the development.

In substep g2, the updated cost and duration estimates for the project are verified to determine what action will be taken. The cost and time spent on making design modifications or re-running tests are assessed, as well as the expected gains to be obtained in reducing uncertainty in each case.

Next, the method executes substep g3): defining whether the technological risk is tolerable for the current Gate. If, at any point, the risk is considered non-tolerable, the method executes substep g3.1): deciding the type of action to be taken, where the outputs provided by DRUM+RM can be used to assess whether, by modifying certain test parameters, such as duration, number of specimens, or applied stress levels, it is possible to achieve the desired reliability target. If this is the case, the method executes substep g3.1.1): suggesting and implementing the design change and return to step (c). This enables a proactive approach to adjusting the planning and execution of the tests, ensuring that the reliability targets are achieved efficiently.

Or, further, if failures are observed in the tests, the multilevel model allows identifying the failure mechanisms, and the associated components, which most contribute to the technological risk of the project, providing guidelines for design modification actions in the equipment. In this case, the method executes substep g3.1.2): returning to step 5 (e), to perform new tests, since failure mechanisms may be introduced and/or removed from the MRM. The processing of partially relevant data may be necessary for a portion of the data obtained for the previous version of the design.

All decisions must be made from the perspective of the impacts on the cost and duration of the project. If such impacts are considered critical, or if a design modification has already been made previously and the process has already returned to step 3 (c) and/or step 5 (e), then it may be decided to consider the unfeasibility of continuing the project in substep g3.1.3), terminating the same. Or, further, the risk associated with Residual Uncertainty may be accepted, to ensure the reduction of the risks related to the cost and duration of the technology development project. To this end, the importance of the criteria—cost, duration, integration and reliability —must be analyzed in the decision-making process.

Thus, the outputs provided by DRUM+RM not only support risk-based decision-making, but also allow for continuous adjustments to the technology development strategy.

On the other hand, if substep (g3) determines that the technological risk is tolerable for the current Gate, the method executes substep g3.2): verifying if the current Gate is the final Gate.

If negative, the method proceeds to substep g3.2.2): advancing to the next Gate and returning to step (f), to continue with the technology development.

If positive, the method proceeds to substep g3.2.1), determining that the equipment is adequate, ending the method.

FIG. 4 illustrates in detail the steps disclosed above.

The method described herein allows for estimating and monitoring the reliability and risk of new equipment throughout all steps of the development process. For this end, the main challenge is to aggregate various types of data, available throughout the process, which need to be analyzed and processed to provide a probability distribution for reliability and the respective uncertainty. The developed method contains statistical tools that use Bayesian inference to aggregate data from multiple sources, such as expert opinions, similar equipment, reliability tests, life tests and/or accelerated degradation tests, computational simulation, and failure physics. In addition, the procedure is based on a multilevel reliability model (MRM), which establishes the analysis of various hierarchical levels and failure modes of the equipment considered, allowing a systemic view of the equipment as a whole. The method is based on the hierarchical construction of the reliability estimate of the equipment under development through the propagation of reliability information at the subsystem/component level to the system level. Thus, the developed method combines tools that had not yet been used together, in the literature or in the industry, to estimate the reliability and risk of new technologies under development. These tools, combined in an unprecedented way, consist of Bayesian inference, multilevel reliability model, failure physics, prior probability distribution estimation about the reliability using data from different sources, including expert opinions and partially relevant data, multi-criteria method for characterization and selection of concepts with respect to the cost, duration, integration and reliability criteria that make up the technological risk.

Although aspects of the present disclosure may be subject to various modifications and alternative forms, specific embodiments have been shown by way of example in the drawings and have been described in detail in this document. But it should be understood that the invention is not intended to be limited to the particular forms disclosed. Instead, the invention shall encompass all modifications, equivalents, and alternatives that fall within the scope of the invention, as defined by the following attached claims.

What is claimed is:

1. A method for monitoring uncertainty regarding the reliability and technological risk associated with the development of new equipment, the method comprising:
a) supporting the allocation process for defining the minimum required reliability level and the maximum tolerated uncertainty;
b) performing selection of concepts, comprising choosing one or more concepts based on a multi-criteria methodology;
c) modeling the reliability of the equipment, comprising:
c1) determining the failure mechanisms and their logical relations;
c2) creating models that describe the reliability of the failure mechanisms; and
c3) developing a multilevel reliability model (MRM);
d) estimating a prior distribution of reliability, including:
d1) eliciting expert opinions; and
d2) collecting and processing partially relevant data;
d3) obtaining a distribution over the MRM parameters; and
d4) obtaining the reliability distribution over mission time;
e) planning reliability tests;
f) Bayesian reliability update, comprising:
f1) collecting data from tests performed at the current Gate;
f2) updating the distribution of the MRM parameters for the current Gate; and
f3) updating the mission time reliability distribution for the current Gate;
g) assessing the technological risk at the current Gate, comprising:
g1) verifying the residual uncertainty about the reliability target;
g2) verifying the updated cost and duration estimates of the project;
g3) defining if the technological risk is tolerable for the current Gate;
g3.1) if not, deciding on the type of action to be taken:
g3.1.1) if design alteration, suggesting and implementing the design change and returning to step (c);
g3.1.2) if new tests are to be performed, returning to step (e);
g3.1.3) if a design modification has already been made and the process has already returned to step 3 (c) and/or to step 5 (e), the technology is considered inadequate and the project is abandoned;
g3.2) if yes, verifying if the current Gate is the final Gate;
g3.2.1) if yes, determining that the equipment is adequate;
g3.2.2) if no, proceeding to the next Gate and returning to step (f).

2. The method according to claim 1, wherein the selection of concepts comprises: modeling the selection problem from a multi-criteria approach, where the alternatives will be compared based on 4 assessment criteria—cost, duration, integration and reliability;
defining the weights of each criterion, according to its relevance in the project for different specialists, via Additive Ratio Assessment (ARAS);
defining value scales of the alternatives for each criterion and assigning the score of each alternative;
obtaining an overall score for each alternative that will determine the final ranking, where the weighted values of the scores for each criterion are combined in the ARAS structure, resulting in a weighted sum.

3. The method according to claim 1, wherein eliciting expert opinions considers experts with different experiences and levels of knowledge regarding the equipment, and that a chief analyst selects which experts will participate in the elicitation process.

4. The method according to claim 1, wherein eliciting expert opinions further comprises:
eliciting the probability of failure of a top event of the FTA and then the probabilities of each failure mode of the FTA;
using the method of moments or the maximum entropy method to estimate the prior distribution for the probability of occurrence of each basic event of the FTA;
propagating the uncertainty based on the prior distributions in a bottom-up approach using Monte Carlo Simulation to find the prior probability distribution of the top event.

5. The method according to claim 1, wherein the Bayesian update of the equipment reliability is performed based on equation 1:
πₖ(θᵢ|E_{i,k})∝πₖ₋₁(θᵢ|E_{i,k-1})×L(E_{i,k}|θᵢ) (1)
where i is a failure event, k is the current Gate, θᵢ is the parameter of the reliability model of the failure mechanism associated with the event i, E_{i,k} is the evidence collected from the test performed on the current Gate, L(E_{i,k}|θᵢ) is the relative likelihood of the reliability model of the failure mechanism associated with the event i, πₖ(θᵢ|E_{i,k}) is the probability distribution over θᵢ on the Gate k.

6. The method according to claim 5, wherein the Bayesian update of the equipment reliability is performed via Markov Chain Monte Carlo (MCMC) and Variational Inference.

7. The method according to claim 1, wherein the MRM comprises Failure Modes, Effects and Criticality Analysis (FMECA) with the addition of a column for stressor, Risk Priority Number (RPN), Fault Tree Analysis (FTA) based on FMECA and Probabilistic Physics of Failure (PPoF) approach to the basic events of the FTA.

8. The method according to claim 1, wherein each Gate is associated with one or more Technology Readiness Levels (TRLs).

9. The method according to claim 2, wherein the selection of concepts occurs before Gate 0 and between Gates 1 and 2.

10. The method according to claim 3, wherein the prior estimation of reliability occurs at Gate 0, during TRL 4 and before the tests are performed.

11. The method according to claim 8, wherein the step of performing equipment tests and obtaining data comprises:
for TRL 4, the data are derived from bench tests at the component level, and consist of test conditions and duration, number of tested specimens, complete, interval and/or censored failure times, and number of observed failures;
for TRL 5, the data are derived from bench tests at the system or subsystem level, and consist of test conditions and duration, number of tested specimens, complete, interval and/or censored failure times, and number of observed failures;
for TRL 6, the data are derived from well laboratory tests at the system level, and consist of test conditions and duration, number of tested specimens, complete, interval and/or censored failure times, and number of observed failures;
for TRL 7, the data are derived from the operation in one well for a predetermined mission time, and consist of complete, interval and/or censored failure times, and the number of observed failures;
for TRL 8, the data are derived from the operation in two additional wells for a predetermined mission time, and consist of complete, interval and/or censored failure times, and the number of observed failures; and
for TRL 9, the data are derived from the operation of the equipment in one or more wells, and consist of complete, interval and/or censored failure times, and the number of observed failures.

12. The method according to claim 1, wherein the technological risk assessment step comprises:
verifying the residual uncertainty on the reliability target, considered by the difference between the uncertainty estimated at the current Gate and the target determined in the target definition step;
verifying the updated cost and duration estimates for the equipment development project and compare them with possible budget and time targets;
defining if the Residual Uncertainty is tolerable for the current Gate and, if so, the development process can: advance to the next Gate from the perspective of the impacts on the cost and duration of the project, or remain at the current Gate to take actions aimed at reducing the Residual Uncertainty;
deciding the type of action to take, if it is defined that the Residual Uncertainty is not tolerable: design modification, conducting new tests, or project termination.

13. The method according to claim 5, wherein each Gate is associated with one or more Technology Readiness Levels (TRLs).

14. The method according to claim 4, wherein the prior estimation of reliability occurs at Gate 0, during TRL 4 and before the tests are performed.

15. The method according to claim 8, wherein the prior estimation of reliability occurs at Gate 0, during TRL 4 and before the tests are performed.
